(19) United States
(12) Patent Application Publication
(10) Pub. No.: US 2010/0240527 A1
(43) Pub. Date: Sep. 23, 2010

(54) PROCESS FOR PRODUCING CATALYST ELECTRODE

(75) Inventors: Atsuhito Yoshizawa, Yokohama-shi (JP); Kazuya Miyazaki, Atsugi-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/792,341

(22) Filed: Jun. 2, 2010

Related U.S. Application Data
(62) Division of application No. 11/614,338, filed on Dec. 21, 2006.

(30) Foreign Application Priority Data
Dec. 22, 2005 (JP) 2005-370825
Dec. 28, 2005 (JP) 2005-378700
Nov. 28, 2006 (JP) 2006-320673

(51) Int. Cl. H01M 4/88

(52) U.S. Cl. 502/101

(57) ABSTRACT

A catalyst electrode is constituted by a catalyst material and a porous carbon frame for carrying the catalyst material. The catalyst material has a structure comprising whiskers or a structure comprising flaky parts. The porous carbon frame has pores having a pore diameter of 0.5 μm or more and 10 μm or less in terms of a mode diameter and has a porosity, in the catalyst electrode, in a range of from 12% to 80%.

### CROSS-REFERENCE TO RELATED APPLICATIONS

This application is a division of application Ser. No. 11/614,338, filed Dec. 21, 2006, which claims priority from Japanese Patent Application Nos. 2005-370825, filed Dec. 22, 2005, 2005-378700, filed Dec. 28, 2005, and 2006-320673, filed Nov. 28, 2006. All prior applications are incorporated herein by reference.

### FIELD OF THE INVENTION AND RELATED ART

The present invention relates to a catalyst electrode, a process for producing the catalyst electrode, and a solid polymer fuel cell (polymer electrolyte fuel cell) having the catalyst electrode.

A polymer electrolyte fuel cell has a high energy conversion efficiency and is clean, so that it is expected as a future energy production apparatus. In recent years, the polymer electrolyte fuel cell is not only used in automobiles or home power generators but also there is a possibility that it can be actuated for a longer time when a conventional secondary battery, because of a high energy density, by being mounted to small-sized electric equipment such as a mobile phone, a notebook computer, or a digital camera, thus receiving attention. However, with respect to automobile use and home use, the polymer electrolyte fuel cell still requires cost reduction. As a method therefor, it is desirable that an amount of usage of catalyst material is decreased. Further, commercialization of the polymer electrolyte fuel cell for the small-size electric equipment requires a compact overall system and an improvement in power generation efficiency.

Such an attempt to increase a surface area so as to enhance utilization efficiency of a catalyst material by providing fine particles of the catalyst material and three-dimensionally dispersing the fine particles while carrying the fine particles on carbon particles has been made. Further, such an attempt to improve a gas diffusion performance in a catalyst layer by providing pores in the catalyst layer to improve substance transport has also been made. Particularly, in the case where the fuel cell is mounted in small-sized electrical equipment, the fuel cell itself is required to be reduced in size. For this reason, a method (air breathing) of supplying air from through holes to an air electrode by natural diffusion without using a pump or a blower has been employed in many cases. In this method, in many cases, substance transport at an air electrode is a reaction rate-determining factor, so that it is considered that an improvement in gas diffusion performance of the catalyst layer is effective means.

As a method of enhancing the catalyst utilization efficiency by improving the gas diffusion performance, Japanese Laid-Open Patent Application (JP-A) No. 2003-200052 haws disclosed a constitution of a catalyst electrode, for a polymer electrolyte fuel cell, including a catalyst material carried on fiber-like carbon particles. Further, JP-A No. 2002-298861 has disclosed an electrode, for a fuel cell, formed by carrying catalyst fine particles on surfaces of carbon nanofibers.

However, it cannot be said that studies on production of a catalyst electrode through a simpler method with greater general versatility and on a catalyst electrode further improved in catalyst utilization factor have been sufficiently made.

### SUMMARY OF THE INVENTION

A principal object of the present invention is to provide a catalyst electrode, for a fuel cell, having a high catalyst utilization factor.

Another object of the present invention is to provide a process for producing the catalyst electrode and a polymer electrolyte fuel cell using the catalyst electrode.

According to an aspect of the present invention, there is provided a catalyst electrode comprising:

a catalyst material; and

a porous carbon frame for carrying the catalyst material,

wherein the catalyst material has a structure comprising whiskers or a structure comprising flaky parts, and

wherein the porous carbon frame has pores having a pore diameter of 0.5 μm or more and 10 μm or less in terms of a mode diameter and has a porosity, in the catalyst electrode, in a range of from 12% to 80%.

The catalyst material may preferably be three-dimensionally dispersed and carried at a surface of and inside the porous carbon frame. The porous carbon frame may preferably comprise carbon powder and a binder comprising a solid polymer electrolyte.

According to another aspect of the present invention, there is provided a catalyst electrode comprising a catalyst material and carbon fibers for carrying the catalyst material, wherein the catalyst material has a nanostructure comprising flaky parts. This catalyst material may preferably has a structure which comprises whiskers has a flaky nanostructural unit. The carbon fibers may preferably be nanotubes or nanofibers. The carbon fibers may preferably have an average diameter of 5 nm or more and 500 nm or less and an average length of 1 μm or more and 100 μm or less.

The catalyst material may preferably be selected from the group consisting of platinum oxide, complex oxide of platinum and metal element other than platinum, platinum or platinum-containing multi-metal element obtained through reduction of the platinum oxide or the complex oxide, a mixture of platinum and oxide of metal element other than platinum, and a mixture of platinum-containing multi-metal element and oxide of metal element other than platinum.

The metal element other than platinum may preferably be at least one species of metal element selected from the group consisting of Al, Si, Ti, V, Cr, Fe, Co, Ni, Cu, Zn, Ge, Zr, Nb, Mo, Ru, Rh, Pd, Ag, In, Sn, Hf, Ta, W, Os, Ir, Au, La, Ce and Nd.

The catalyst material may preferably comprise whiskers having an average thickness of 5 nm or more and 50 nm or less or flaky parts having an average thickness of 5 nm or more and 50 nm or less.

According to another aspect of the present invention, there is provided a process for producing a catalyst electrode comprising a catalyst material and a porous carbon frame for carrying the catalyst material, the process comprising a step of forming the catalyst material at a surface of or inside the porous carbon frame by sputtering, vacuum deposition or ion plating in a vapor phase.

According to a further aspect of the present invention, there is provided a process for producing a catalyst electrode comprising a catalyst material having a structure comprising an aggregate of flaky parts and carbon fibers for carrying the catalyst material, the process comprising a step of forming the catalyst material by reactive vacuum deposition.

The carbon fibers may preferably be formed by thermal CVD (chemical vapor deposition).

According to a still further aspect of the present invention, there is provided a polymer electrolyte fuel cell comprising a catalyst electrode described above and a solid polymer electrolyte disposed adjacent to the catalyst electrode.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view showing an embodiment of a cross-sectional structure of a single cell of a polymer electrolyte fuel cell using a catalyst electrode according to the present invention.

FIGS. 2A to 2C are photographs, (magnification: 1×10⁴ (FIG. 2A), 3×10⁴ (FIG. 2B), and 30×10⁴ (FIG. 2C) taken by a scanning electron microscope (SEM), showing a particle structure of a catalyst material for a catalyst electrode according to Embodiment 1 of the present invention.

FIGS. 3A and 3B are photographs, (magnification: 1×10⁴ (FIG. 3A) and 3×10⁴ (FIG. 3B)) taken by a SEM, showing a particle structure of a catalyst material for a catalyst electrode according to Embodiment 2 of the present invention.

FIGS. 4A and 4B are photographs, (magnification: 1×10⁴ (FIG. 4A) and 3×10⁴ (FIG. 4B)) taken by a SEM, showing a particle structure of a catalyst material for a catalyst electrode according to Comparative Embodiment 1.

FIG. 5 is a schematic view of an evaluation apparatus of the polymer electrolyte fuel cell.

FIG. 6 is a graph showing cell characteristics of polymer electrolyte fuel cells prepared by using catalyst electrodes according to Embodiment 1, Embodiment 2, and Comparative Embodiment 1.

FIG. 7 is a graph showing distributions of pore diameters of porous carbon frames in Embodiment 1 and Embodiment 2.

FIG. 8 is a schematic view showing another embodiment of a cross-sectional structure of a single cell of a polymer electrolyte fuel cell using a catalyst electrode according to the present invention.

FIG. 9 is a photograph, (magnification: 5×10⁴) taken by a SEM, showing a particle structure of a catalyst material for a catalyst electrode according to Embodiment 3 of the present invention.

### DETAILED DESCRIPTION OF THE PREFERRED EMBODIMENTS

Herein below, preferred embodiments of the catalyst electrode for a polymer electrolyte fuel cell and production process thereof according to the present invention will be described more specifically with reference to the drawings. In the following description, however, materials, dimensions, shapes, relative arrangements, and the like of constitutional members usable in the present invention are not limited to those described below unless otherwise specified. Similarly, a production process described later is not an exclusive embodiment.

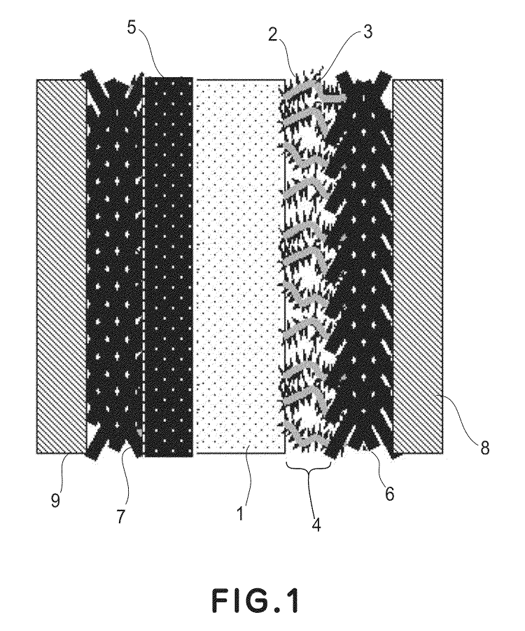

FIG. 1 is a schematic view showing an embodiment of a cross-sectional structure of a single cell of a polymer electrolyte fuel cell using the catalyst electrode of the present invention.

Referring to FIG. 1, the single cell includes a solid polymer electrolyte membrane 1, a pair of cathode side catalyst electrode 4 and an anode-side catalyst electrode 5 disposed to sandwich the solid polymer electrolytic membrane 1, a cathode-side gas diffusion layer 6 disposed outside the cathode-side catalyst electrode 4, an anode-side gas diffusion layer 7 disposed outside the anode-side catalyst electrode 5, a cathode-side collector 8 disposed outside the cathode-side gas diffusion layer 6, and an anode-side collector 9 disposed outside the anode-side gas diffusion layer 7.

In this embodiment, only as the cathode-side catalyst electrode, such a particular catalyst electrode that a catalyst material having whiskers or a structure comprising flaky parts is three-dimensionally dispersed at a surface of and inside a porous carbon frame is used. However, a constitution of disposition of the catalyst electrode in the present invention is not limited thereto. For example, the disposition constitution may also include the case where both of the anode-side catalyst electrode and the cathode-side catalyst electrode are constituted by the particular catalyst electrode in the present invention and the case where only the anode-side catalyst electrode is constituted by the particular catalyst electrode. In the present invention, the disposition constitution of the particular catalyst electrode in the present invention can be appropriately selected from the above described constitutions.

Referring again to FIG. 1, the single cell further include a catalyst material 2 and a catalyst material carrier 3 which is a porous carbon frame in this embodiment. The catalyst electrode 4 is constituted by the catalyst material 2 and the catalyst material carrier 3.

It is preferable that the catalyst material 2 is selected from the group consisting of platinum oxide, complex oxide of platinum and metal element other than platinum, platinum or platinum-containing multi-metal element obtained through reduction of the platinum oxide or the complex oxide, a mixture of platinum and oxide of metal element other than platinum, and a mixture of platinum-containing multi-metal element and oxide of metal element other than platinum.

Further, the metal element other than platinum may preferably be at least one species of metal element selected from the group consisting of Al, Si, Ti, V, Cr, Mn, Fe, Co, Ni, Cu, Zn, Ge, Zr, Nb, Mo, Ru, Rh, Pd, Ag, In, Sn, Hf, Ta, W, Os, Re, Ir, Au, La, Ce and Nd.

The catalyst material 2 has the whiskers or the structure comprising flaky parts.

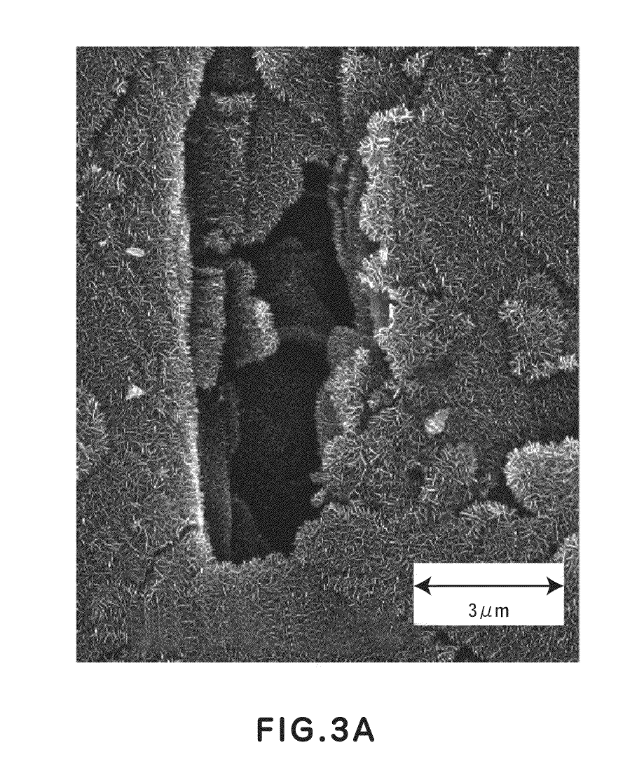

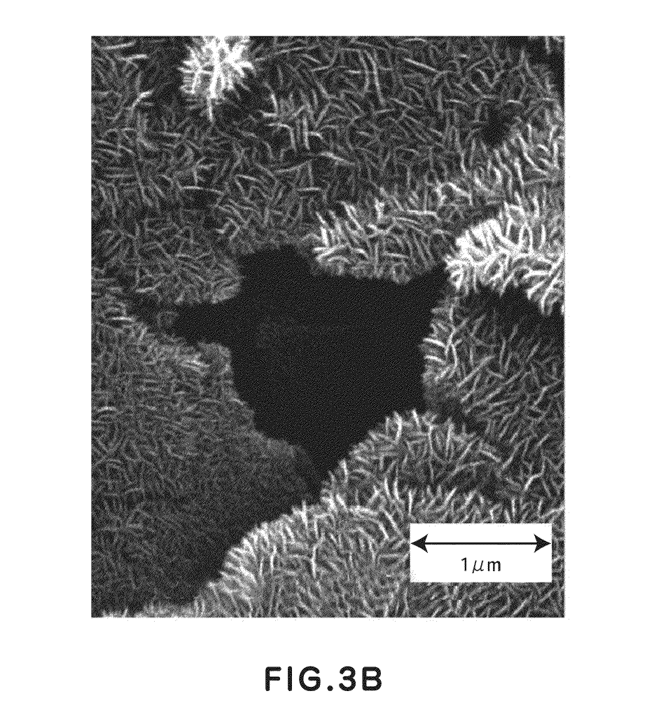

Herein, the structure comprising whiskers means a structure comprising an aggregate of the whiskers. Referring to FIGS. 3A and 3B showing photographs (magnification: 1×10⁴ for FIGS. 3A and 3×10⁴ for FIG. 3B) of a catalyst electrode of Embodiment 2 taken by an SEM, portions comprising whiskers represent the catalyst material 2 and constitute the aggregate structure of the whiskers.

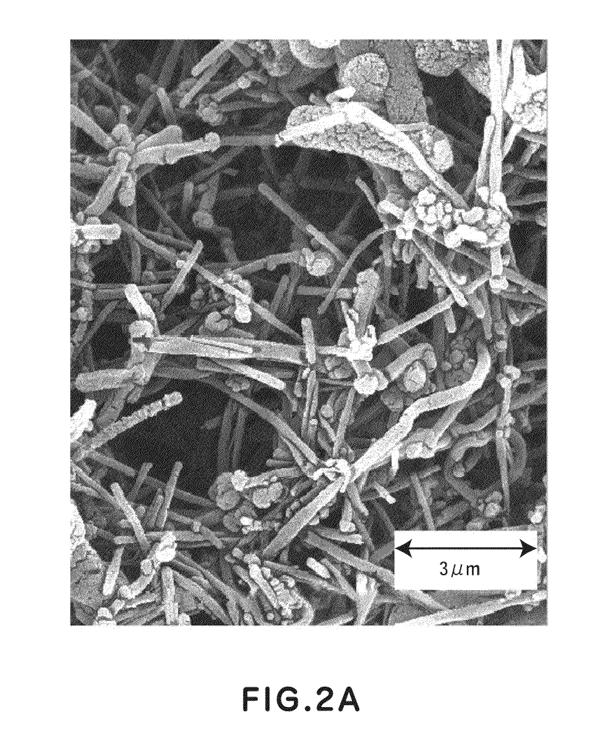

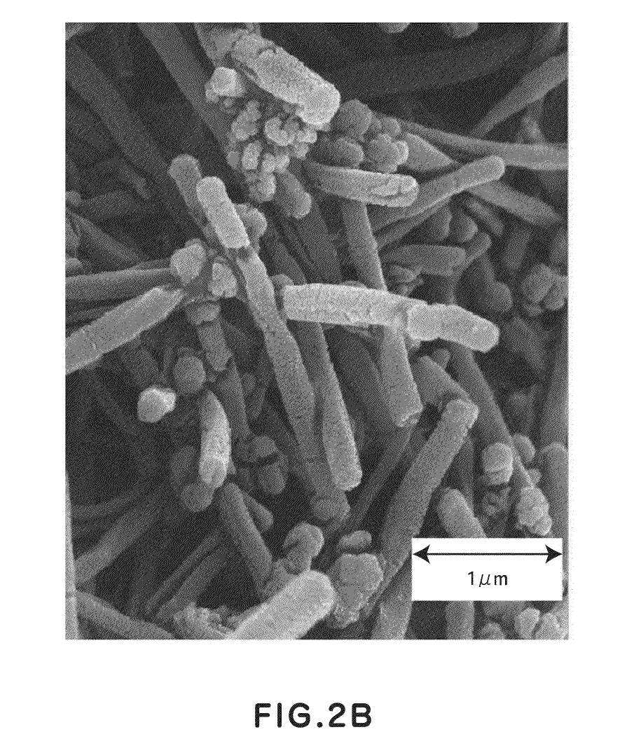

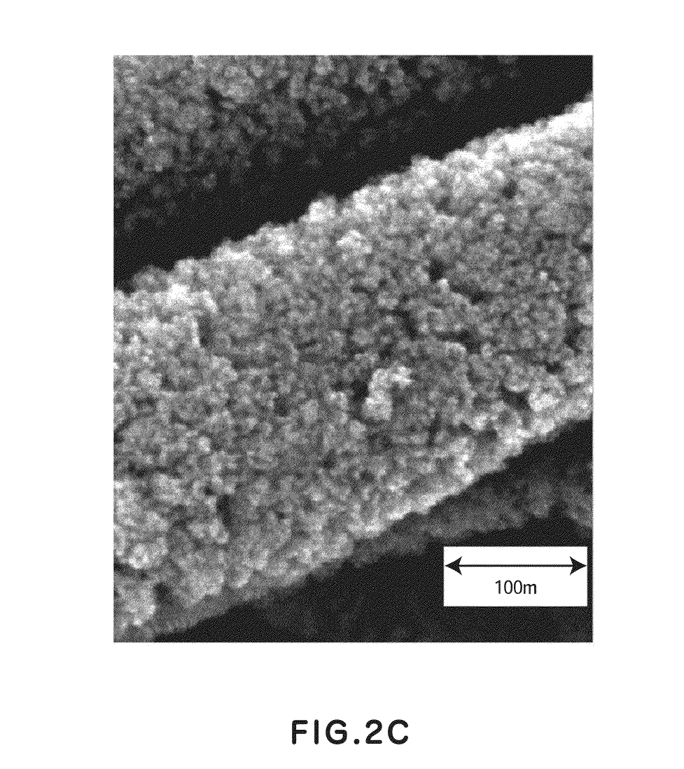

Further, the structure comprising flaky parts means a structure comprising an aggregate of the flaky parts. Referring to FIGS. 2A to 2C showing photographs (magnification: 1×10⁴ for FIGS. 2A and 3×10⁴ for FIG. 2B, and 30×10⁴ for FIG. 2C) of a catalyst electrode of Embodiment 1 taken by an SEM, portions comprising flaky parts represent the catalyst material 2 and constitute the aggregate structure of the flaky parts.

Incidentally, in the case where the catalyst material is formed by utilizing a reduction process after sputtering as described later, when an amount of the catalyst material is small, the catalyst material is liable to have the structure comprising flaky parts. On the other hand, when the amount of the catalyst material is large, the catalyst material is liable to have the structure comprising whiskers. When the structure comprising whiskers is observed in detail, it has a flaky nanostructural unit in some cases but in the present invention, the structure comprising whiskers conceptually membranes such cases.

The catalyst material having the structure comprising whiskers or the structure comprising flaky parts comprises whiskers or flaky parts. These whiskers or flaky parts may preferably have an average thickness of 5 nm or more and 50 nm or less, more preferably 5 nm or more and 20 nm or less.

The catalyst material having the above described form, composition, constitution, and dimension may suitably be formed by a physical deposition method in a vapor phase, such as sputtering, vacuum deposition, or ion plating, or reactive vacuum deposition. For example, platinum oxide having the structure comprising whiskers or the structure comprising flaky parts can be easily coated on a surface of the porous carbon frame by reactive sputtering using a platinum target, so that the whiskers or the flaky parts can be three-dimensionally dispersed at the surface and inside the porous carbon frame.

In FIG. 1, the porous carbon frame 3 has pores and comprises a carbon sheet in which the pores are three-dimensionally connected. The pores in the porous carbon frame 3 may desirably have a pore diameter of 0.5 μm or more and 10 μm or less, more desirably 1.0 μm or more and 10 μm or less, in terms of a mode diameter. Further, the porous carbon frame may preferably have a porosity of 12% or more and 80% or less, more preferably 40% or more and 80% or less. Herein, the porosity means a ratio of a volume of pores to a sample volume obtained by multiplying a sample area by a sample thickness.

Further, the catalyst electrode may preferably have a thickness of 5 μm or more and 30 μm or less, more preferably 10 μm or more and 25 μm or less.

As a carbon material for the porous carbon frame, it is possible to suitably select and combine materials, such as carbon nanotube, Ketjen black, carbon powder (“VGCF”, mfd. by SHOWA DENKO K.K.), flaky carbon (mfd. by Nippon Graphite Industries, Ltd.), and carbon black “Vulcan XC-72R”, mfd. by Cabot Corporation).

The porous carbon frame is obtained by preparing slurry of the above described carbon material together with a binder such as Teflon (registered trademark), or solid polymer electrolytic solution and a dispersion medium such as isopropyl alcohol (IPA) and applying the slurry onto a sheet of Teflon. Further, it is also possible to form the porous carbon frame by directly applying the slurry onto the gas diffusion layer.

The catalyst electrode comprising the catalyst material, having the structure comprising whiskers or the structure comprising flaky parts, dispersed three-dimensionally at the surface of and inside the above prepared porous carbon frame can be bound to the solid polymer electrolytic membrane by a transfer method. In this case, it is possible to employ a method wherein a solid polymer electrolytic solution as a proton conductive material is added dropwise to the catalyst electrode or a method wherein the catalyst electrode is transferred by utilizing the solid polymer electrolyte used during the preparation of the porous carbon frame as actuated as a cell. In the latter method, however, there is such a problem that the solid polymer electrolyte contrast in a high vacuum atmosphere in sputtering to break a binding state between the carbon material components, so that the catalyst electrode is decreased in strength and broken during the transfer. Further, a proton conduction path is broken, so that a utilization rate of the catalyst material is remarkably lowered. For these reasons, in order to realize the transfer and power generation, it is necessary to add an organic solvent, such as IPA or ethanol, dropwise to the catalyst electrode after the sputtering to dissolve and dry the solid polymer electrolyte so as to be bound to each other again.

Further, on the above prepared catalyst electrode, the porous carbon frame is formed again to form a catalyst layer by sputtering, so that a lamination of the catalyst electrode can be effected. In this case, it is also possible to improve a water holding property and proton conductivity of the electrolyte membrane by adding a larger amount of the solid polymer electrolyte to the porous carbon frame of the electrode close to the solid polymer electrolytic membrane. Further, by adding a larger amount of Teflon to the porous carbon frame of the electrode close to the gas diffusion layer so as to improve water repellency and anti-flooding property, it is also possible to improve the function of the catalyst electrode.

As a material for the solid polymer electrolytic membrane, it is possible to suitably use a perfluorosulfonic acid polymer having such a structure that a side chain having a terminal sulfonic acid group is connected to a fluorocarbon skeleton.

The perfluorosulfonic polymer has the fluorocarbon skeleton which is not crosslinked and has such a crystal structure formed by skeleton portions connected by Van der Waals force. Further, some sulfonic acid groups are agglomerated to form an inverted micelle structure which is used as a proton (H⁺) conduction channel.

Incidentally, when the proton (H⁺) is moved toward the cathode side in the electrolytic membrane, it is moved through the medium of water molecule. Therefore, the electrolytic membrane may also preferably have the function of holding water molecule.

Accordingly, as the functions of the solid polymer electrolyte membrane, it is required that the proton (H⁺) produced on the anode side is transferred to the cathode side and that the electrolytic membrane is not permeable to unreacted reactive gases (hydrogen and oxygen) and has a predetermined water-holding function. So long as these requirements are fulfilled, it is possible to selective use any electrolytic membrane.

The gas diffusion layers 6 and 7 may preferably have the function of sufficiently supplying fuel gas or air uniformly in an in-plane direction to an electrode reaction area of a fuel electrode or an air electrode in order to effect the electrode reaction efficiently. Further, the diffusion layers also have the function of dissipating electric charges generated by an anode electrode reaction toward the outside of the single cell and efficiently discharging reaction product water or unreacted gas toward the outside of the single cell. As a material for the gas diffusion layers, it is possible to preferably use an electron-conductive porous material such as carbon cloth or carbon paper.

The catalyst electrode and polymer electrolyte fuel cell in this embodiment can be prepared by various methods. An example thereof will be described using the catalyst electrode shown in FIGS. 2A to 2C.

The catalyst electrode shown in FIGS. 2(a) to 2(c) is obtained through a sputtering method by three-dimensionally dispersing a catalyst material at a surface of and inside a porous carbon frame prepared using carbon powder (“VGCF”).

### (1) Preparation of Porous Carbon Frame as Catalyst Carrier

Carbon power (“VGCF”), a solid polymer electrolytic solution (5%-solution of “Nafion”, mfd. by DuPont), and IPA (mfd. by Kishida Chemical Co., Ltd.) are mixed in a predetermined mixing ratio to obtain slurry. The resultant slurry is applied onto a polytetrafluoroethylene (PTFE) sheet as a transfer layer with respect to the polymer electrolytic membrane by means of a doctor blade to obtain a porous carbon frame as a supporting member.

(2) Formation of Catalyst Material with Respect to Porous Carbon Frame

The supporting member prepared in the above step (1) is moved in a sputtering apparatus and subjected to film formation of a catalyst material of platinum oxide having a structure comprising whiskers or a structure comprising flaky parts at a rate of about 0.25 mg/cm². More specifically, after an inner pressure of a sputtering chamber is reduced to a pressure of 1.0×10⁻⁴ Pa, Ar and O₂ are introduced in the sputtering chamber at flow rates of 2.5 sccm and 20.0 sccm, respectively, and a total pressure is adjusted to 6.0 Pa at an orifice. Reactive sputtering is effected at Rf supplied power of 4.0 W/cm² to form a film of platinum oxide having the structure comprising whiskers or the structure comprising flaky parts at a rate of about 0.25 mg/cm². In this case, the supporting member has sufficient pores and holes, so that the sputtered catalyst material of platinum oxide is three-dimensionally dispersed and disposed not only at the surface of the porous carbon frame but also inside the porous carbon frame.

The supporting member after completion of the film formation is exposed to 2% H₂/He at 10 kPa to be easily subjected to reduction, thus resulting a cathode-side catalyst electrode.

### (3) Preparation of Anode-Side Catalyst Electrode

As a catalyst material for an anode as a counter electrode, platinum-supported carbon (“Hi SPEC 4000”, mfd. by Johnson Matthey Plc) is used.

The platinum-supported carbon, a solid polymer electrolytic solution (5%-solution of “Nafion”, mfd. by DuPont), and IPA are mixed in a predetermined mixing ratio to obtain slurry. The resultant slurry is applied onto a PTFE sheet as a transfer layer with respect to the polymer electrolytic membrane by means of a doctor blade to obtain an anode-side catalyst electrode.

### (4) Preparation of MEA (Membrane-Electrode Assembly)

A solid polymer electrolytic membrane (“Nafion 112”, mfd. by DuPont) is sandwiched between the above prepared cathode-side catalyst electrode and anode-side catalyst electrode and then is subjected to hot pressing. Thereafter, the PTFE sheets are removed, so that the pair of catalyst electrodes is transferred onto the solid polymer electrolytic membrane to obtain an assembly of the electrolytic membrane and the pair of catalyst electrodes. This assembly is sandwiched between gas diffusion layers of carbon cloth (“LT 1400-W”, mfd. by E-TEK, Inc.) and is further sandwiched between a fuel electrode and an air electrode to prepare a single cell.

Hereinbelow, an embodiment in which carbon fibers are used as a carrier for the catalyst material will be described. In the present specification, the porous carbon frame and the carbon fibers are described as different materials. However, it is quite reasonable to regard an aggregate of carbon fibers as a porous carbon frame. In other words, the embodiment using the carbon fibers in the present invention includes an embodiment using a porous carbon frame consisting of the aggregate of carbon fibers.

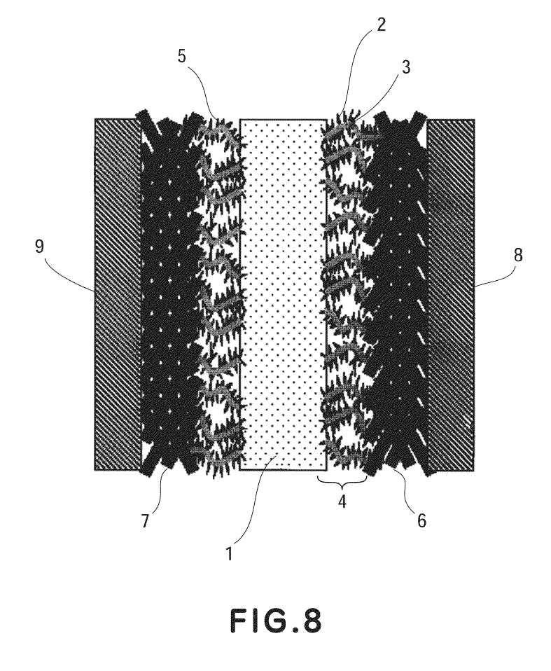

FIG. 8 is a schematic view showing another embodiment of a cross-sectional structure of a single cell of a polymer electrolyte fuel cell using the catalyst electrode of the present invention. The single cell shown in FIG. 8 has the same constitution as that of the single cell shown in FIG. 1 except that a catalyst carrier 3 is used for both of the catalyst electrodes 4 and 5 and formed of carbon fibers. In FIG. 8, other reference numerals represent members identical to those shown in FIG. 1.

In this embodiment, both of the catalyst electrodes 4 and 5 are such a catalyst electrode that a catalyst material comprising an aggregate of flaky parts or having a structure comprising whiskers constituted by an aggregate of flaky parts is formed on carbon fibers. However, such a catalyst electrode may also be disposed, e.g., only as the cathode-side catalyst electrode or the anode-side catalyst electrode. These dispositions of catalyst electrodes may appropriately be selected in the present invention.

In this embodiment, the catalyst material 2 has the structure comprising the aggregate of flaky parts, particularly preferably the structure comprising whiskers constituted by the aggregate of flaky parts. For example, a catalyst material of platinum oxide having the structure comprising the aggregate of flaky parts can be easily coated on carbon fibers by reactive sputtering with a platinum target.

In this embodiment, the carbon fibers constituting the catalyst carrier 3 comprise fibers having a graphite structure. More specifically, as the carbon fibers, it is possible to use plate-type GNFs (graphite nanofibers) such that c axis of graphenes is parallel to a fiber length direction, herring-bone-type GNFs such that c axis of graphenes is inclined with respect to the fiber length direction, and a so-called CNTs (carbon nanotubes) such that c axis of graphenes is perpendicular to the fiber length direction.

These GNFs or CNTs can be formed by a so-called thermal CVD in which a supporting member containing Pd, Fe, Co, Ni or alloys of these as a carbon fiber forming catalyst is heated at 300-800° C. in a reduced-pressure atmosphere reactor containing carbon-containing gas or a mixture of carbon-containing gas and hydrogen gas.

The above described carbon fibers have a diameter which can be controlled by a thickness of the carbon fiber forming catalyst or a particle size of the carbon fiber forming catalyst after a reduction aggregation process. An average diameter thereof is 5 nm or more and 500 nm or less, preferably 50 nm or more and 300 nm or less. The carbon fibers have an average length of 1 μm or more and 100 μm or less, preferably 10 μm or more and 50 μm or less.

The thus formed, on the carbon fibers, catalyst material comprising the aggregate of flaky parts or the structure comprising whiskers constituted by the aggregate flaky parts can be transferred onto the solid polymer electrolytic membrane. Further, the catalyst electrode removed from the supporting member on which the carbon fibers are disposed can be mixed with an electrolytic solution, an organic solvent, and water to prepare catalyst slurry and then the catalyst slurry can be applied onto the electrolytic membrane. Further, it is also possible to employ a method (Decal method) in which the catalyst slurry is applied onto a sheet of Teflon as a transfer layer by a blade method and then is transferred onto the electrolytic membrane.

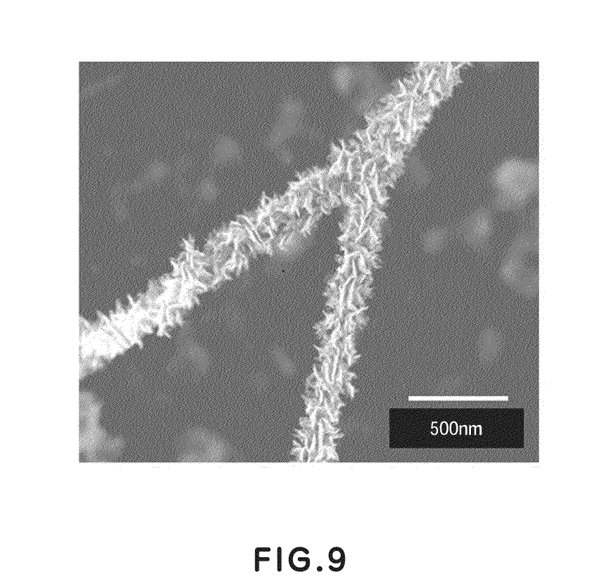

In this embodiment, the catalyst electrode and a polymer electrolyte fuel cell can be produced by various methods. An example thereof will be described using a catalyst electrode shown in FIG. 9, which is a SEM photograph (magnification: 5×10⁴) showing a particle structure of a catalyst material for a catalyst electrode in Embodiment 3. The catalyst electrode shown in FIG. 9 is formed of a catalyst material of platinum oxide having a structure comprising whiskers on a GNF carrier.

(1) GNFs as a catalyst carrier are prepared. More specifically, on a supporting member of Si, Pd—Co fine particles (Co: 50 atomic %) as a GNF forming catalyst are formed in a thickness of about 20 nm and placed in a reaction vessel of the thermal CVD, followed by vacuum evacuation and then reduction aggregation of Pd—Co fine particles under heating at 600° C. for 10 min. Thereafter, in the reaction vessel, acetylene (1%)-helium (99%) gas and hydrogen gas (100%) are introduced both at a flow rate of 20 sccm and a total pressure is kept at 2 kPa. A supporting member temperature in the reaction vessel is increased up to 800° C. and kept for 20 min., so that GNFs having an average diameter of about 50 nm grow on the supporting member in a thickness of about 20 μm.

(2) Next, the thus prepared supporting member is moved in a sputtering apparatus in which a catalyst material of platinum oxide having the structure comprising whiskers is formed in a film having a thickness of about 100 nm. More specifically, after an inner pressure of a sputtering chamber is reduced to a pressure of 1.0×10⁻⁴ Pa, Ar and O₂ are introduced in the sputtering chamber at flow rates of 2.5 sccm and 20.0 sccm, respectively, and a total pressure is adjusted to 6.0 Pa at an orifice. Reactive sputtering is effected at Rf supplied power of 4.0 W/cm² to form a film of platinum oxide having the structure comprising whiskers or the structure comprising flaky parts in a thickness of about 100 nm. In this case, sputtered atoms are moved to and deposited on the supporting member with no directivity, so that the film of platinum oxide is effectively formed on the surfaces of GNFs at a coating ratio of substantially 100%.

The supporting member after completion of the film formation is exposed to 2% H₂/He at 10 kPa to be easily subjected to reduction.

(3) The catalyst electrode after the reduction is effected is subjected to ionomer treatment. More specifically, to a surface of the catalyst electrode, a Nafion dispersion having adjusted concentration, solvent and the like is added dropwise.

(4) A solid polymer electrolytic membrane (“Nafion 112”, mfd. by DuPont) is sandwiched between the above prepared pair of catalyst electrodes and then is subjected to hot pressing. Thereafter, the Si substrate is removed, so that the pair of catalyst electrodes is transferred onto the solid polymer electrolytic membrane to obtain an assembly of the solid polymer electrolytic membrane and the pair of catalyst electrodes.

(5) This assembly is sandwiched between gas diffusion layers of carbon cloth (“LT 1400-W”, mfd. by E-TEK, Inc.) and is further sandwiched between a fuel electrode and an air electrode to prepare a single cell.

As described above, the processes for producing the single cells for the polymer electrolyte fuel cells are explained based on the catalyst electrodes shown in FIGS. 2A to 2C and FIG. 9, respectively. However, the present invention is not limited to such a polymer electrolyte fuel cell of a single cell-type but may also include a polymer electrolyte fuel cell of the type wherein a plurality of single cells is stacked.

### EMBODIMENTS

The present invention will be described in detail based on specific embodiments.

### Embodiment 1

In this embodiment, a catalyst material is three-dimensionally dispersed at a surface of and inside a porous carbon frame using carbon powder (“VGCF”, mfd. by SHOWA DENKO K.K.).

Hereinafter, production steps of a polymer electrolyte fuel cell according to this embodiment will be described more specifically.

### (Step 1)

First, a porous carbon frame as a catalyst carrier is prepared.

Carbon power (“VGCF”), a solid polymer electrolytic solution (5%-solution of “Nafion”, mfd. by DuPont), and IPA are mixed and dispersed in a predetermined mixing ratio to obtain slurry. The resultant slurry is applied onto a polytetrafluoroethylene (PTFE) sheet as a transfer layer with respect to the polymer electrolytic membrane by means of a doctor blade to obtain a 20 μm-thick porous carbon frame as a supporting member.

### (Step 2)

The supporting member prepared in the Step (1) is moved in a sputtering apparatus and subjected to film formation of a catalyst material of platinum oxide having a structure comprising whiskers or a structure comprising flaky parts at a thickness (rate) of about 0.25 mg/cm². More specifically, after an inner pressure of a sputtering chamber is reduced to a pressure of 1.0×10⁻⁴ Pa, Ar and O₂ are introduced in the sputtering chamber at flow rates of 2.5 sccm and 20.0 sccm, respectively, and a total pressure is adjusted to 6.0 Pa at an orifice. Reactive sputtering is effected at Rf supplied power of 4.0 W/cm² to form, on the porous carbon frame, a film of platinum oxide having the structure comprising whiskers or the structure comprising flaky parts at a thickness (rate) of about 0.25 mg/cm². In this case, the supporting member has sufficient pores and holes, so that the sputtered catalyst material of platinum oxide is three-dimensionally dispersed and disposed not only at the surface of the porous carbon frame but also inside the porous carbon frame.

The supporting member after completion of the film formation is exposed to 2% H₂/He at 10 kPa to be easily subjected to reduction.

After the reduction, IPA is added dropwise to the supporting member in an amount of 0.3 cc/cm² to dissolve Nafion in the porous carbon frame, followed by drying in an atmosphere of ambient air to cause mutual binding of Nafion again, thus obtaining a cathode-side catalyst electrode.

### (Step 3)

Next, as a counter electrode, an anode-side catalyst electrode is prepared.

As a anode catalyst material, platinum-supported carbon (“Hi SPEC 4000”, mfd. by Johnson Matthey Plc) is used.

The platinum-supported carbon, a solid polymer electrolytic solution (5%-solution of “Nafion”, mfd. by DuPont), and IPA are mixed in a predetermined mixing ratio to obtain slurry. The resultant slurry is applied onto a PTFE sheet as a transfer layer with respect to the polymer electrolytic membrane by means of a doctor blade to obtain an anode-side catalyst electrode.

### (Step 4)

A solid polymer electrolytic membrane (“Nafion 112”, mfd. by DuPont) is sandwiched between the above prepared cathode-side catalyst electrode and anode-side catalyst electrode and then is subjected to hot pressing. Thereafter, the PTFE sheets are removed, so that the pair of catalyst electrodes is transferred onto the solid polymer electrolytic membrane to obtain an assembly of the electrolytic membrane and the pair of catalyst electrodes. This assembly is sandwiched between gas diffusion layers of carbon cloth (“LT 1400-W”, mfd. by E-TEK, Inc.) and is further sandwiched between a fuel electrode and an air electrode to prepare a single cell.

In this embodiment, electric power generation is effected using the solid polymer electrolyte (“Nafion”) used during the preparation of the porous carbon frame, so that it is not necessary to add the solid polymer electrolyte after the catalyst material is added to the porous carbon frame.

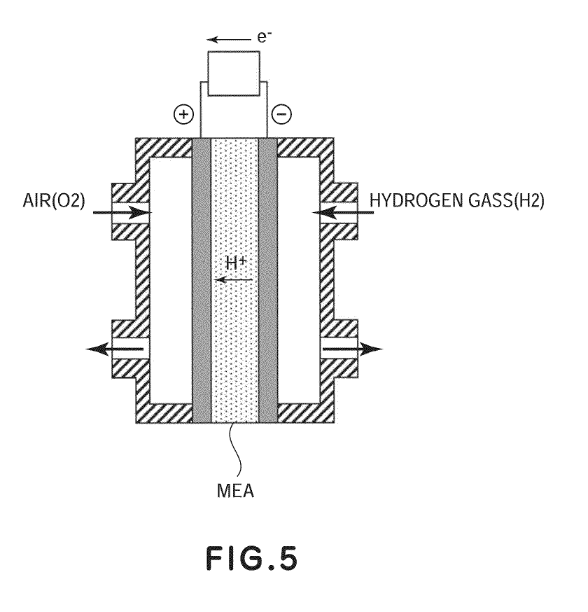

The thus prepared single cell was evaluated with respect to a cell characteristic by an evaluation apparatus shown in FIG. 5.

Hydrogen gas was supplied to the anode electrode-side and air was supplied to the air electrode-side to effect a discharge test at a cell temperature of 80° C.

### Comparative Embodiment 1

As a comparative embodiment, a single cell was prepared and evaluated in the same manner as in Embodiment 1 except that the sputtering of platinum oxide was directly effected with respect to the gas diffusion layer without using the porous carbon frame.

With respect to the thus prepared single cells of Embodiment 1 and Comparative Embodiment 1, the shapes of electrodes are compared.

FIGS. 2A to 2C show SEM photographs each showing a particle structure of the catalyst material for the catalyst electrode of Embodiment 1, wherein the photographs are taken at magnifications of 1×10⁴ (FIG. 2A), 3×10⁴ (FIG. 2B), and 30×10⁴ (FIG. 2C), respectively.

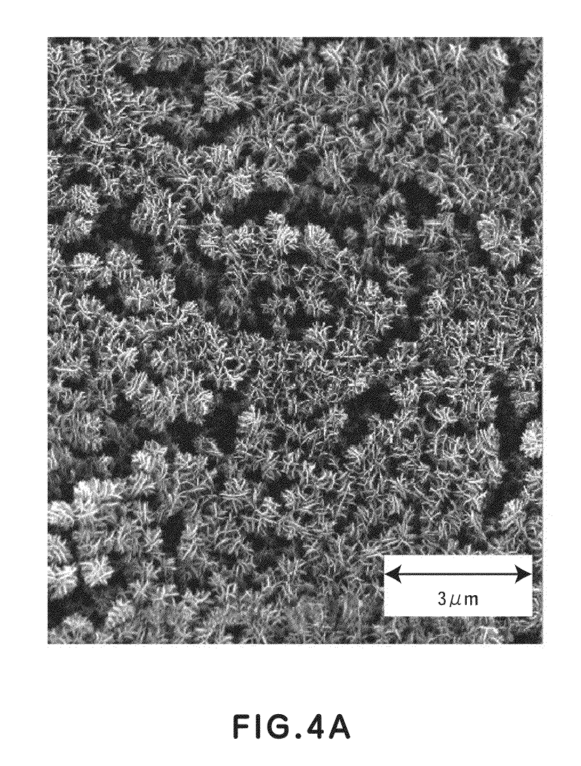

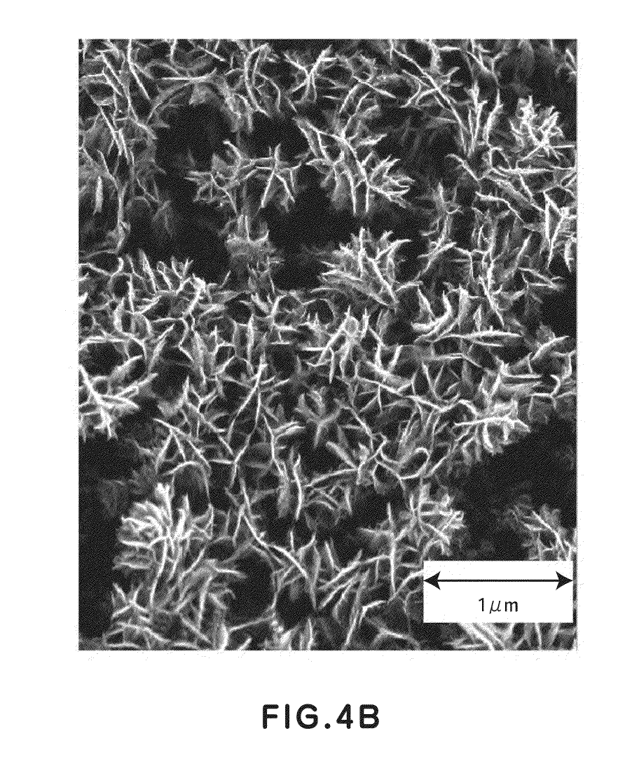

FIGS. 4A and 4B show SEM photographs each showing a particle structure of the catalyst material for the catalyst electrode of Comparative Embodiment 1, wherein the photographs are taken at magnifications of 1×10⁴ (FIG. 4A) and 3×10⁴ (FIG. 4B), respectively.

In Comparative Embodiment 1, such a structure comprising whiskers that the whiskers (catalyst material) are extended in a film thickness direction of the solid polymer electrolytic membrane is observed.

On the other hand, in Embodiment 1, although the same amount of platinum is sputtered, such a structure comprising flaky parts that the flaky parts have an average thickness of 5 nm or more and 50 nm or less at an initial formation stage is observed. This may be attributable to an increase in sputtering area because of disposition of the flaky parts disposed three-dimensionally not only at the surface of the porous carbon frame but also inside the porous carbon frame.

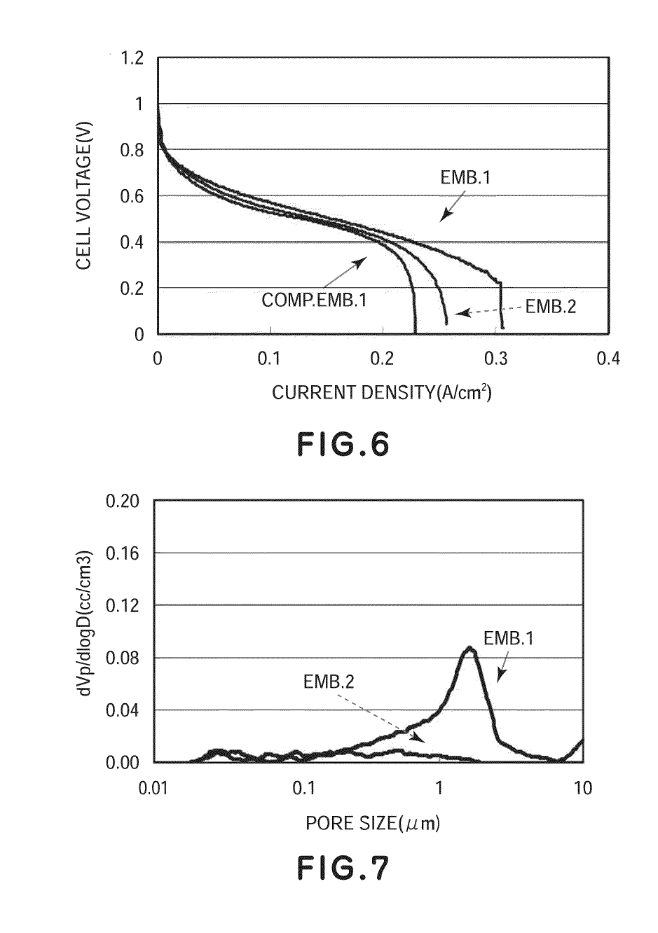

Next, current (I)-voltage (V) curves in Embodiment 1 and Comparative Embodiment 1 are shown in FIG. 6.

When limiting current densities providing a cell voltage of 0 V are compared, the single cell of Comparative Embodiment 1 provides a limiting current density of 0.212 A/cm² and the single cell of Embodiment 1 provides a limiting current density of 0.327 A/cm². Further, the single cell of Comparative Embodiment 1 provides cell voltages of 0.542 V and 0.310 V at current densities of 0.1 A/cm² and 0.2 A/cm², respectively. On the other hand, the single cell of Embodiment 1 provides higher cell voltages of 0.617 V and 0.499 V at current densities of 0.1 A/cm² and 0.2 A/cm², respectively.

Further, in Embodiment 1, when IPA was not added after the sputtering during the preparation of the catalyst electrode, a limiting current density was 0.0048 mA/cm², thus being a very low value. This means that the step of dissolution and re-binding of Nafion by dropwise addition of IPA after the sputtering is indispensable.

As described above, according to Embodiment 1 of the present invention, a good diffusion characteristic of gas and a sufficient water discharge characteristic are ensured by three-dimensionally dispersing the catalyst material at the surface of and inside the porous carbon frame, so that it is possible to improve performances by formation of a three-phase interface and suppression of flooding of electrode due to produced water.

As described above, by using the catalyst electrode according to this embodiment as a catalyst layer of a polymer electrolyte fuel cell, it is possible to provide a fuel cell having excellent cell characteristic through good three-phase interface formation and suppression of flooding of electrode due to produced water. Further, the production process of the catalyst electrode according to this embodiment is a simple and in expensive process with good reproducibility, so that it is possible to realize a polymer electrolyte fuel cell having a stable characteristic at low cost.

### Embodiment 2

In this embodiment, a catalyst electrode is prepared by using carbon powder (“GR-15” (flaky carbon), mfd. by Nippon Graphite Industries, Ltd.) as a material for a porous carbon frame.

In this embodiment, production steps of a polymer electrolyte fuel cell are the same as those in Embodiment 1 except for Step 1 described below.

### (Step 1)

First, a porous carbon frame as a catalyst carrier is prepared.

Carbon power (“GR-15”), a solid polymer electrolytic solution (5%-solution of “Nafion”, mfd. by DuPont), and IPA are mixed and dispersed in a predetermined mixing ratio to obtain slurry. The resultant slurry is applied onto a polytetrafluoroethylene (PTFE) sheet as a transfer layer with respect to the polymer electrolytic membrane by means of a doctor blade to obtain a 20 μm-thick porous carbon frame as a supporting member.

The thus prepared single cell was evaluated with respect to a cell characteristic by an evaluation apparatus shown in FIG. 5.

Hydrogen gas was supplied to the anode electrode-side and air was supplied to the air electrode-side to effect a discharge test at a cell temperature of 80° C.

With respect to the thus prepared single cells of Embodiment 2 and the above prepared single cell of Comparative Embodiment 1, the shapes of electrodes are compared.

FIGS. 3A to 3B show SEM photographs each showing a particle structure of the catalyst material for the catalyst electrode of Embodiment 2, wherein the photographs are taken at magnifications of 1×10⁴ (FIG. 2A) and 3×10⁴ (FIG. 2B), respectively.

As described above, FIGS. 4A and 4B show SEM photographs each showing a particle structure of the catalyst material for the catalyst electrode of Comparative Embodiment 1, wherein the photographs are taken at magnifications of 1×10⁴ (FIG. 4A) and 3×10⁴ (FIG. 4B), respectively.

In Embodiment 2, different from Embodiment 1, the shape of the catalyst material in Embodiment 2 has a structure comprising whiskers similar to that in Comparative Embodiment 1. The whiskers of the structure comprising whiskers in Embodiment 2 have an average diameter is 20 nm.

The structure comprising whiskers in Embodiment 2 is different from the structure comprising whiskers in Comparative Embodiment 1 in that the whiskers in Comparative Embodiment 1 grow and extend in a direction perpendicular to the electrolytic membrane thickness direction but the whiskers in Embodiment 2 grow in a direction parallel to the electrolytic membrane thickness direction.

Next, current (I)-voltage (V) curves in Embodiment 2 and Comparative Embodiment 1 are shown in FIG. 6.

When limiting current densities providing a cell voltage of 0 V are compared, the single cell of Comparative Embodiment 2 provides a limiting current density of 0.229 A/cm² and the single cell of Embodiment 1 provides a limiting current density of 0.327 A/cm². Further, the single cell of Comparative Embodiment 1 provides cell voltages of 0.542 V and 0.310 V at current densities of 0.1 A/cm² and 0.2 A/cm², respectively. On the other hand, the single cell of Embodiment 2 provides higher cell voltages of 0.527 V and 0.390 V at current densities of 0.1 A/cm² and 0.2 A/cm², respectively. In Embodiment 2, compared with Comparative Embodiment 1, the limiting current density is slightly increased but a degree of the increase is less than that in Embodiment 1.

Next, the above described cell characteristics of the polymer electrolyte fuel cells prepared in Embodiment 1, Embodiment 2, and Comparative Embodiment 1 are summarized in Table 1.

TABLE 1

| | COMP. EMB. 1 | EMB. 1 | EMB. 2 |
|---|---|---|---|
| Limiting current | 0.212 | 0.327 | 0.229 |
| density (A/cm²) | | | |
| Cell voltage (V) | 0.542 | 0.617 | 0.527 |
| (at 0.1 A/cm²) | | | |
| Cell voltage (V) | 0.310 | 0.499 | 0.390 |
| (at 0.2 A/cm²) | | | |

Further, distributions of pores in the porous carbon frames in Embodiment 1 and Embodiment 2 are shown in FIG. 7, and pore diameters in terms of mode diameters obtained therefrom and porosities in the catalyst electrodes in Embodiment 1 and Embodiment 2 are shown in Table 2.

TABLE 2

| | EMB. 1 | EMB. 2 |
|---|---|---|
| Pore diameter (μm) | 1.7 | 0.5 |
| (mode diameter) | | |
| Porosity (%) | 50 | 12 |

From the results of Embodiment 2, an effect as the porous carbon frame is achieved even when the pore diameter (mode diameter) is 0.5 μm or more and 10 μm or less and the porosity is 12% or more and 80% or less. However, from the results of Embodiment 1, the porous carbon frame may desirably provide a pore diameter (mode diameter) of 1.0 μm or more and 10 μm or less and a porosity of 40% or more and 80% or less.

By using such a porous carbon frame, the catalyst material prepared by sputtering is effectively dispersed and distributed not only at the surface of the porous carbon frame but also inside the porous carbon frame. As a result, a good gas diffusion characteristic and a sufficient water discharge characteristic are ensured, so that it is possible to considerably improve fuel cell performances by formation of a good three-phase interface and suppression of flooding of electrode due to produced water.

### Embodiment 3

In this embodiment, a catalyst material of platinum having a structure comprising whiskers is formed on a GNF carrier. Production steps of a polymer electrolyte fuel cell according to this embodiment will be described in detail.

### (Step 1)

GNFs as a catalyst carrier were prepared. More specifically, on a supporting member of Si, Pd—Co fine particles (Co: 50 atomic %) as a GNF forming catalyst were formed in a thickness of about 20 nm and placed in a reaction vessel of the thermal CVD, followed by vacuum evacuation and then reduction aggregation of Pd—Co fine particles under heating at 600° C. for 10 min. Thereafter, in the reaction vessel, acetylene (1%)-helium (99%) gas and hydrogen gas (100%) were introduced both at a flow rate of 20 sccm and a total pressure was kept at 2 kPa. A supporting member temperature in the reaction vessel was increased up to 800° C. and kept for 20 min., so that GNFs having an average diameter of about 50 nm grew on the supporting member in a thickness of about 20 μm.

### (Step 2)

Next, the thus prepared supporting member was moved in a sputtering apparatus in which a catalyst material of platinum oxide having the structure comprising whiskers was formed in a film. More specifically, after an inner pressure of a sputtering chamber was reduced to a pressure of 1.0×10⁻⁴ Pa, Ar and O₂ were introduced in the sputtering chamber at flow rates of 2.5 sccm and 20.0 sccm, respectively, and a total pressure was adjusted to 6.0 Pa at an orifice. Reactive sputtering was effected at Rf supplied power of 4.0 W/cm² to form, on the GNFs, a film of platinum oxide having the structure comprising whiskers or the structure comprising flaky parts at a rate of 50 μg/cm² for an anode and a rate of 0.5 mg/cm² for a cathode. In this case, sputtered atoms were moved to and deposited on the supporting member with no directivity, so that the film of platinum oxide was effectively formed on the surfaces of GNFs at a coating ratio of substantially 100%. FIG. 9 is a SEM photograph (magnification: 5×10⁴) showing a particle structure of a catalyst material for a catalyst electrode of this embodiment, i.e., a catalyst electrode having a structure comprising whiskers constituted by an aggregate of flaky parts of platinum oxide on graphite nanofibers.

The supporting member after completion of the film formation of platinum oxide was exposed to 2% H₂/He at 10 kPa to be easily subjected to reduction.

### (Step 3)

The catalyst electrode after the reduction was effected is subjected to ionomer treatment. More specifically, to a surface of the catalyst electrode, a Nafion dispersion having adjusted concentration, solvent and the like was added dropwise. An anode-side catalyst electrode and a cathode-side catalyst electrode were treated in the same manner.

### (Step 4)

A solid polymer electrolytic membrane (“Nafion 112”, mfd. by DuPont) was sandwiched between the above prepared pair of catalyst electrodes and then was subjected to hot pressing. Thereafter, the Si substrate was removed, so that the pair of catalyst electrodes was transferred onto the solid polymer electrolytic membrane to obtain an assembly of the solid polymer electrolytic membrane and the pair of catalyst electrodes.

This assembly was sandwiched between gas diffusion layers of carbon cloth (“LT 1400-W”, mfd. by E-TEK, Inc.) and is further sandwiched between a fuel electrode and an air electrode to prepare a single cell.

The thus prepared single cell was evaluated with respect to a cell characteristic by an evaluation apparatus shown in FIG. 5.

Hydrogen gas was supplied to the anode electrode-side and air was supplied to the air electrode-side to effect a discharge test at a cell temperature of 80° C.

### Comparative Embodiment 2

As another comparative embodiment, a single cell prepared by the Decal method using a platinum-supported carbon material was evaluated in the same manner as in Embodiment 3.

First, a current density at 900 my providing a reaction rate-determining area was compared between the single cells of Embodiment 3 and Comparative Embodiment 2. As a result, the current density was 7.4 mA/cm² in Embodiment 3 and 2.0 mA/cm² in Comparative Embodiment 2. Further, a catalyst specific activity obtained by dividing the current density by a catalyst carrying amount (equivalent in cathode-side catalyst) was compared. As a result, the catalyst specific activity was 14.8 A/g in Embodiment 3 and 5.7 A/g in Comparative Embodiment 2.

When a limiting current area was compared, the current density of the single cell prepared in Embodiment 3 was 600 mA/cm² or more. On the other hand, in Comparative Embodiment 2, the current density was 520 mA/cm².

In other words, compared with the catalyst electrode in Comparative Embodiment 2, the catalyst electrode in Embodiment 3 was capable of considerably improve a characteristics in terms of any of activity polarization, resistance polarization and diffusion polarization.

Further, when a test of actuation characteristic was effected after these single cells were placed in the same initial state, the single cell of Comparative Embodiment 2 failed to provide a sufficient characteristic at an initial actuation stage. On the other hand, the single cell of Embodiment 3 was capable of substantially providing rated output from the initial actuation stage.

As described above, by using the catalyst electrode according to this embodiment as a catalyst electrode of a polymer electrolyte fuel cell, it is possible to remarkably improve the catalyst activity thereby to provide a fuel cell having excellent cell characteristic. Further, the production process of the catalyst electrode according to Embodiment 3 is a simple and in expensive process with good reproducibility, so that it is possible to realize a polymer electrolyte fuel cell having a stable characteristic at low cost.

### Embodiment 4

In this embodiment, a complex catalyst material of platinum-palladium having a structure comprising whiskers is formed on a GNF carrier. Production steps of a polymer electrolyte fuel cell in this embodiment are the same as those in Embodiment 3 except for Steps 1 to 3 described below.

### (Step 1)

GNFs as a catalyst carrier were prepared. More specifically, on a supporting member of Si, Ni fine particles as a GNF forming catalyst were formed in a thickness of about 20 nm and placed in a reaction vessel of the thermal CVD, followed by vacuum evacuation and then reduction aggregation of Ni fine particles under heating at 600° C. for 10 min. Thereafter, in the reaction vessel, acetylene (1%)-helium (99%) gas and hydrogen gas (100%) were introduced both at a flow rate of 20 sccm and a total pressure was kept at 2 kPa. A supporting member temperature in the reaction vessel was increased up to 800° C. and kept for 20 min., so that GNFs having an average diameter of about 100 nm grew on the supporting member in a thickness of about 30 μm.

### (Step 2)

Next, the thus prepared supporting member was moved in a sputtering apparatus in which a catalyst material of complex oxide of platinum-palladium having the structure comprising whiskers was formed in a film. More specifically, after an inner pressure of a sputtering chamber was reduced to a pressure of 1.0×10⁻⁴ Pa, Ar and O₂ were introduced in the sputtering chamber at flow rates of 2.5 sccm and 20.0 sccm, respectively, and a total pressure was adjusted to 6.0 Pa at an orifice. Reactive sputtering was effected at Rf supplied power of 4.0 W/cm² for a platinum target and 2.5 W/cm² for a palladium target to form, on the GNFs, a film of platinum oxide having the structure comprising whiskers or the structure comprising flaky parts at a rate of 50 μg/cm² for an anode and a rate of 0.4 mg/cm² for a cathode. In this case, sputtered atoms were moved to and deposited on the supporting member with no directivity, so that the film of complex oxide of platinum-palladium was effectively formed on the surfaces of GNFs at a coating ratio of substantially 100%.

The supporting member after completion of the film formation was exposed to 2% H₂/He at 10 kPa to be easily subjected to reduction.

### (Step 3)

The catalyst electrode after the reduction was effected is subjected to ionomer treatment. More specifically, to a surface of the catalyst electrode, a Nafion dispersion having adjusted concentration, solvent and the like was added dropwise.

The thus prepared single cell was evaluated with respect to a cell characteristic by an evaluation apparatus shown in FIG. 5.

Hydrogen gas was supplied to the anode electrode-side and air was supplied to the air electrode-side to effect a discharge test at a cell temperature of 80° C. The results were compared with those of Comparative Embodiment 2 described above.

First, a current density at 900 my providing a reaction rate-determining area was compared. As a result, the current density was 7.2 mA/cm² in Embodiment 4 and 2.0 mA/cm² in Comparative Embodiment 2. Further, a catalyst specific activity obtained by dividing the current density by a catalyst carrying amount (equivalent in cathode-side catalyst) was compared. As a result, the catalyst specific activity was 9.0 A/g in Embodiment 4 and 5.7 A/g in Comparative Embodiment 2.

When a limiting current area was compared, the current density of the single cell prepared in Embodiment 4 was 600 mA/cm² or more. On the other hand, in Comparative Embodiment 2, the current density was 520 mA/cm².

In other words, compared with the catalyst electrode in Comparative Embodiment 2, the catalyst electrode in Embodiment 4 was capable of considerably improve a characteristics in terms of any of activity polarization, resistance polarization and diffusion polarization.

Further, when a test of actuation characteristic was effected after these single cells were placed in the same initial state, the single cell of Comparative Embodiment 2 failed to provide a sufficient characteristic at an initial actuation stage. On the other hand, the single cell of Embodiment 4 was capable of substantially providing rated output from the initial actuation stage.

As described above, by using the catalyst electrode according to this embodiment as a catalyst electrode of a polymer electrolyte fuel cell, it is possible to remarkably improve the catalyst activity thereby to provide a fuel cell having excellent cell characteristic. Further, the production process of the catalyst electrode according to Embodiment 4 is a simple and in expensive process with good reproducibility, so that it is possible to realize a polymer electrolyte fuel cell having a stable characteristic at low cost.

As described hereinabove, according to the present invention, the good three-phase interface is formed and the flooding of electrode due to produced water is suppressed, so that it is possible to improve performances of the polymer electrolyte fuel cell. Further, the catalyst electrode of the present invention can be produced by a simple general-purpose method, so that it is possible to realize stabilization and uniformization of performance of membrane-catalyst electrode assembly.

According to the present invention, it is possible to provide a catalyst electrode improved in utilization rate of catalyst material and a production process of the catalyst electrode for a polymer electrolyte fuel cell through the simple general-purpose method. Further, it is also possible to inexpensively provide a polymer electrolyte fuel cell having an electric power generation characteristic which is uniform and stable for a long period of term.

While the invention has been described with reference to the structures disclosed herein, it is not confined to the details set forth and this application is intended to cover such modifications or changes as may come within the purpose of the improvements or the scope of the following claims.

What is claimed is:

1. A process for producing a catalyst electrode comprising a catalyst material and a porous carbon frame for carrying the catalyst material, the process comprising:
a step of forming a catalyst precursor at a surface of or inside the porous carbon frame by subjecting a platinum oxide or complex oxide of platinum and a metal element other than platinum to sputtering, vacuum deposition, or ion plating in a presence of oxygen; and
a step of subjecting the catalyst precursor to reduction.

2. A process for producing a catalyst electrode comprising a catalyst material having a nanostructure comprising flaky parts and carbon fibers for carrying the catalyst material, the process comprising:
a step of forming a catalyst precursor on the carbon fibers by subjecting platinum oxide or a complex oxide of platinum and a metal element other than platinum to sputtering, vacuum deposition, or ion plating in a presence of oxygen; and
a step of subjecting the catalyst precursor to reduction.

3. The process according to claim 2, wherein the carbon fibers are formed by thermal chemical vapor deposition.
